(19) United States
(12) Patent Application Publication
(10) Pub. No.: US 2026/0336470 A1
(43) Pub. Date: Oct. 29, 2026

(54) CHARGING CONTROL APPARATUS FOR VEHICLE

(71) Applicant: SUBARU CORPORATION, Tokyo (JP)

(72) Inventor: Takahiro KINOSHITA, Tokyo (JP)

(21) Appl. No.: 19/715,579

(22) Filed: Jun. 22, 2026

Related U.S. Application Data
(63) Continuation of application No. PCT/JP2024/005048, filed on Feb. 14, 2024.

(51) Int. Cl. B60L 58/13; B60L 58/20

(52) U.S. Cl. CPC B60L 58/13; B60L 58/20; B60L 2240/545

(57) ABSTRACT

A charging control apparatus includes a processor(s) and a storage medium. The storage medium stores a program that causes the processor(s)to: acquire a remaining charge amount of an auxiliary battery of a vehicle and a temperature of the auxiliary battery in a ready OFF state in which the vehicle involves difficulty in traveling; start charging of the auxiliary battery when the remaining charge amount is less than a lower limit threshold that includes a value that is configured to prevent a system of the vehicle from becoming difficult to start; stop the charging of the auxiliary battery when the remaining charge amount is equal to or greater than an upper limit threshold that includes a value greater than the lower limit threshold; and repeatedly execute a charging control process that includes setting, based on the temperature of the auxiliary battery, the upper limit threshold and the lower limit threshold.

### CROSS-REFERENCE TO RELATED APPLICATIONS

This application is continuation of International Application No. PCT/JP2024/005048, filed on Feb. 14, 2024, the entire content of which are hereby incorporated by reference.

### BACKGROUND

The disclosure relates to a charging control apparatus for a vehicle which controls charging of an in-vehicle battery mounted on the vehicle.

Electric vehicles able to travel without using fuel such as gasoline have become popular. Such an electric vehicle includes, in addition to an auxiliary battery, a large-capacity traveling battery to be used for traveling of the vehicle.

The auxiliary battery is used for starting of a system of the vehicle. Accordingly, the vehicle can suffer from difficulties in starting and thus can become difficult to travel, when a remaining charge amount of the auxiliary battery is excessively decreased in a ready OFF state of the vehicle.

Japanese Unexamined Patent Application Publication No. 2006-174619 discloses a technique in which charging of the auxiliary battery is performed with a remaining charge amount of the traveling battery, when the remaining charge amount of the auxiliary battery is decreased. This prevents the excessive decrease in the remaining charge amount of the auxiliary battery in the ready OFF state of the vehicle, and avoids a non-travelable state of the vehicle.

### SUMMARY

An aspect of the disclosure provides a charging control apparatus for a vehicle. The charging control apparatus includes one or more processors and a storage medium. The storage medium is configured to store a program configured to be executed by the one or more processors. The program includes one or more commands. The one or more commands are configured to cause the one or more processors to: acquire a remaining charge amount of an auxiliary battery of the vehicle and a temperature of the auxiliary battery in a ready OFF state in which the vehicle involves difficulty in traveling; start charging of the auxiliary battery when the remaining charge amount of the auxiliary battery is less than a lower limit threshold, in which the lower limit threshold includes a value that is configured to prevent a system of the vehicle from becoming difficult to start; stop the charging of the auxiliary battery when the remaining charge amount of the auxiliary battery is equal to or greater than an upper limit threshold, in which the upper limit threshold includes a value greater than the lower limit threshold, and repeatedly execute a charging control process that comprises setting, based on the temperature of the auxiliary battery, the upper limit threshold and the lower limit threshold.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating a configuration example of a vehicle mounted with a charging control apparatus for a vehicle according to one example embodiment of the disclosure.

FIG. 2 is a block diagram illustrating a configuration example of a controller illustrated in FIG. 1.

FIG. 3 is a block diagram illustrating a configuration example of a central ECU illustrated in FIG. 1.

FIG. 4 is a diagram illustrating an example of setting of a lower limit threshold and an upper limit threshold to be used for a management of SOC of an auxiliary battery illustrated in FIG. 1.

FIG. 5 is a diagram illustrating another example of the setting of the lower limit threshold and the upper limit threshold to be used for the management of the SOC of the auxiliary battery illustrated in FIG. 1.

FIG. 6 is a diagram illustrating an example in which the lower limit threshold and the upper limit threshold are changed based on an internal temperature that changes in response to an elapse of time.

FIG. 7 is a flowchart illustrating an example of a charging control process to be executed by the central ECU.

### DETAILED DESCRIPTION

A lithium-ion battery is sometimes used as an auxiliary battery instead of a lead battery. The lithium-ion battery, however, is higher in cost than the lead battery. Accordingly, the cost of the lithium-ion battery is to be reduced by reducing, for example, the capacity.

When the capacity of the lithium-ion battery as the auxiliary battery is reduced, charging of the auxiliary battery is to be performed more frequently to prevent the battery from running out upon parking of a vehicle.

If a state of charge (SOC) is erroneously managed in a charging control of the auxiliary battery, a charge capacity reduced as a result of the reduction in the capacity may possibly be further decreased.

It is desirable to provide a charging control apparatus for a vehicle which makes it possible to suppress a further decrease in a charge capacity due to a deterioration of an auxiliary battery whose capacity is reduced.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Configuration of Vehicle

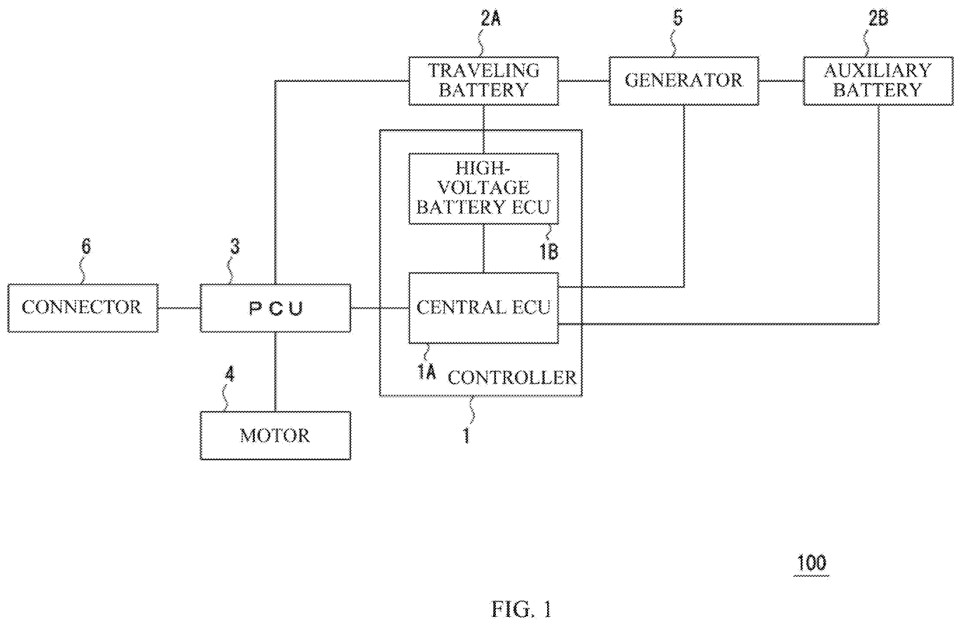

FIG. 1 illustrates a configuration example of a vehicle 100 mounted with a charging control apparatus according to an example embodiment of the disclosure.

The vehicle 100 may include a controller 1, an in-vehicle battery 2, a power control unit (PCU) 3, a motor 4, a generator 5, and a connector 6.

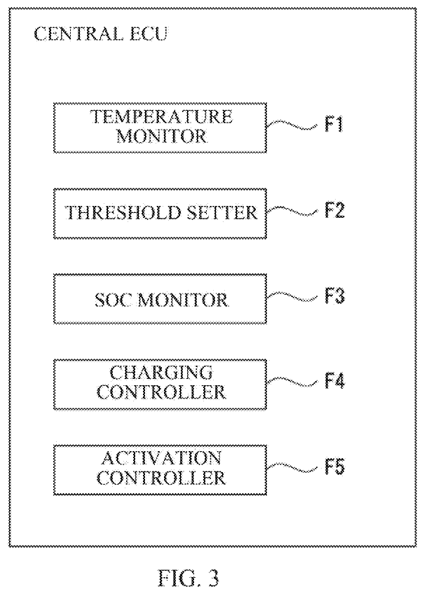

Note that FIG. 3 illustrates some configurations mounted on the vehicle 100. The vehicle 100 may include, as appropriate, non-illustrated devices including, for example, a map locator, various sensors for driving of the vehicle 100, and a communication device.

The controller 1 may perform an overall control of the vehicle 100. The controller 1 may be provided as a single unit, or may be configured by a plurality of electronic control units (ECUs). Non-limiting examples of the ECUs may include: a central ECU 1A that comprehensively manages and controls the vehicle 100; a high-voltage battery ECU 1B that performs a control such as a charging control of a high-voltage battery; a display control ECU that performs a display control of a display device included in the vehicle 100; an airbag control ECU, and an air-conditioning control ECU. The display device may include a device such as a meter.

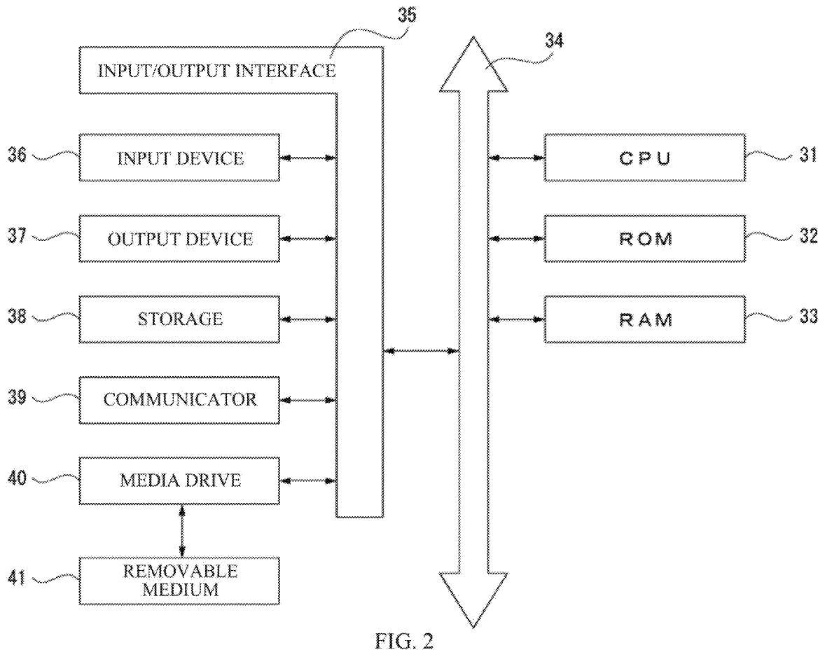

Referring to FIG. 2, the controller 1 or one or more of various ECUs described above may have devices including, for example: a central processing unit (CPU) 31; a read-only memory (ROM) 32; a random-access memory (RAM) 33; a bus 34; an input/output interface 35; an input device 36; an output device 37; a storage 38; a communicator 39; and a media drive 40. Note that a part of the devices may be selectively provided for each of the ECUs as appropriate. For example, not all the ECUs may not be provided with all the configurations illustrated in FIG. 2.

The CPU 31 may execute various processes in accordance with a program stored in the ROM 32 or a program loaded from the storage 38 into the RAM 33. The RAM 33 may also hold data and the like to be used for the CPU 31 to execute various processes.

The CPU 31, the ROM 32, and the RAM 33 may be coupled to each other via the bus 34. The input/output interface 35 may also be coupled to the bus 34.

The input/output interface 35 may be coupled to the input device 36, the output device 37, the storage 38, the communicator 39, and the media drive 40.

The input device 36 may receive signals from various sensors coupled to a device such as the controller 1.

The output device 37 may output control data for a device such as an actuator coupled to the ECU. The actuators may drive respective components of the vehicle 100. The output device 37 may be a display or a speaker to notify a user of various pieces of information. The display may be any display such as a liquid crystal display (LCD) or an organic electroluminescence (EL) display.

The storage 38 may be any storage device such as a hard disk drive (HDD) or a flash memory device.

The communicator 39 may perform a communication process that performs a communication with any other ECU. The communication may be performed via a controller area network (CAN). The communicator 39 may be designed to communicate with an external device such as a server via a communication network outside the vehicle 100.

The media drive 40 may be mounted as necessary with a removable medium 41. Non-limiting examples of the removable medium 41 may include a semiconductor memory, a magnetic disk, an optical disk, and a magneto-optical disk. The media drive 40 may write and read data to and from the removable medium 41.

The central ECU 1A may be a controller that achieves various processes and operations by cooperating with various ECUs and components. For example, the central ECU 1A may give display instructions to the display control ECU at an appropriate timing to provide a desired displaying to an occupant. The central ECU 1A may cooperate with the airbag control ECU to activate the airbag and improve the safety of the occupant accordingly, when a predetermined condition is satisfied.

The controller 1 may perform an operation such as controlling charging of the in-vehicle battery 2 mounted on the vehicle 100 or managing a remaining charge amount (SOC: State Of Charge) of the in-vehicle battery 2.

The vehicle 100 may include a plurality of batteries as the in-vehicle battery 2. For example, the vehicle 100 may include a traveling battery 2A and an auxiliary battery 2B. The traveling battery 2A may be the in-vehicle battery 2 that is higher in voltage as compared with the auxiliary battery 2B.

The traveling battery 2A may be a high-voltage battery of several hundred volts to be used for traveling of the vehicle 100. The traveling battery 2A may supply electric power to be used f or driving of wheels and electric power to be used for an operation of an air conditioner of the vehicle 100. FIG. 1 illustrates a supply of electric power to be used for driving of the wheels from the traveling battery 2A. Note that the illustration of a supply of electric power to be used for operations of the other components are omitted in FIG. 1.

The high-voltage battery ECU 1B may perform, for example, management of the traveling battery 2A that is relatively high in voltage out of the in-vehicle batteries 2.

The high-voltage battery ECU 1B may be coupled to sensors to be used for the management of the traveling battery 2A. The high-voltage battery ECU 1B may perform operations including, for example, charging and discharging and a temperature control of the traveling battery 2A, based on detected values obtained from the sensors. Non-limiting examples of the sensor may include a voltage sensor, a current sensor, and a temperature sensor.

The traveling battery 2A may be charged based on a DC voltage supplied from the PCU 3. The traveling battery 2A may provide, to the PCU 3, a power supply voltage for driving of the motor 4.

The PCU 3 may include devices including, for example, an inverter and a DC/DC converter for driving of the motor 4.

The PCU 3 may generate an AC current to be used for driving of the motor 4, based on the supplied power supply voltage, and supply the AC current to the motor 4. The PCU 3 may control a torque of the motor 4 by controlling the AC current. The PCU 3 may optimize an energy efficiency that utilizes a regenerative energy by performing a control that causes the motor 4 to perform a regenerative braking.

The motor 4 may be configured as a motor generator that generates electric power, and drive the wheels based on the supplied AC current.

The connector 6 may have a structure in which a charging plug included in charging equipment provided at each home or charging station is insertable. The connector 6 may output, to the PCU 3, an AC voltage supplied through the inserted charging plug. The PCU 3 may charge the traveling battery 2A by supplying, to the traveling battery 2A, a DC voltage converted by an AC/DC converter included in the PCU 3.

In some embodiments, the auxiliary battery 2B may be a lithium-ion battery. The lithium-ion battery may have an example voltage of 12 volts. The auxiliary battery 2B may supply driving electric power to various auxiliary machines mounted on the vehicle 100. Non-limiting examples of the auxiliary machine may include various lights, a navigation system, audio equipment, and wipers.

The central ECU 1A may perform, for example, management of the auxiliary battery 2B that is relatively low in voltage out of the in-vehicle batteries 2.

The central ECU 1A according to an example embodiment may receive data on the SOC from the auxiliary battery 2B, and perform a charging control of the auxiliary battery 2B by activating each component, when the SOC falls below a threshold. The generator 5 may be used to charge the auxiliary battery 2B.

The generator 5 may include a device such as a DC/DC converter. The generator 5 may charge the auxiliary battery 2B by stepping down the high-voltage electric power supplied from the traveling battery 2A and supplying the thus-lowered electric power to the auxiliary battery 2B. For example, the generator 5 may charge the auxiliary battery 2B, based on instructions received from the central ECU 1A.

### 2. Configuration of Central ECU 1A

FIG. 3 illustrates an example of a configuration of the central ECU 1A.

The central ECU 1A may include a temperature monitor F1, a threshold setter F2, a SOC monitor F3, a charging controller F4, and an activation controller F5.

The temperature monitor F1 may monitor an internal temperature Tin of the auxiliary battery 2B. For example, the internal temperature Tin of the auxiliary battery 2B may be estimated based on temperature data acquired from a temperature sensor provided on a surface of the auxiliary battery 2B or provided inside the auxiliary battery 2B.

The threshold setter F2 may set a lower limit threshold Th1 and an upper limit threshold Th2, based on the internal temperature Tin of the auxiliary battery 2B obtained by the temperature monitor F1.

In some embodiments, the lower limit threshold Th1 may be set to about 30% to 50%. The lower limit threshold Th1 may be a threshold at which the charging of the auxiliary battery 2B is started.

In some embodiments, the upper limit threshold Th2 may be set to about 60% to 80%. The upper limit threshold Th2 may be a threshold at which the charging of the auxiliary battery 2B is stopped.

For example, the threshold setter F2 may set 50% as the lower limit threshold Th1 and set 80% as the upper limit threshold Th2 when the internal temperature Tin of the auxiliary battery 2B is less than a first temperature T1. The auxiliary battery 2B can involve a decrease in an output characteristic when the internal temperature Tin is low. Accordingly, the auxiliary battery 2B may be managed at the higher SOC in order to avoid a non-startup state of a system of the vehicle 100.

For example, the threshold setter F2 may set 30% as the lower limit threshold Th1 and 60% as the upper limit threshold Th2 when the internal temperature Tin of the auxiliary battery 2B is equal to or higher than a second temperature T2. The deterioration of the auxiliary battery 2B can become large if the auxiliary battery 2B is managed at the higher SOC when the internal temperature Tin is high. Accordingly, the auxiliary battery 2B may be managed at the lower SOC in order to prevent a promotion of the decrease in the capacity due to the deterioration of the auxiliary battery 2B.

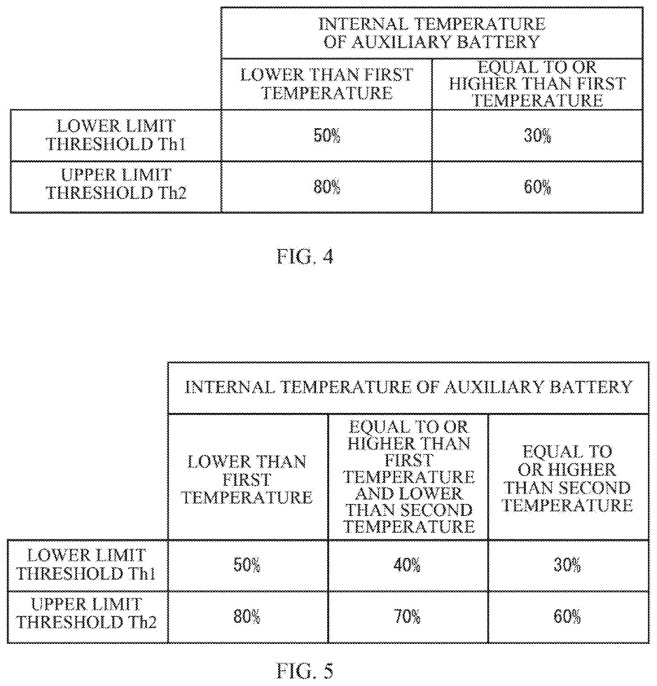

In some embodiments, the first temperature T1 and the second temperature T2 may be the same in temperature. For example, as illustrated in FIG. 4, the auxiliary battery 2B may be managed at the higher SOC when the internal temperature Tin of the auxiliary battery 2B is lower than a certain temperature, and may be managed at the lower SOC when the internal temperature Tin is equal to or higher than the certain temperature.

In some embodiments, the first temperature T1 may be a temperature lower than the second temperature T2. For example, as illustrated in FIG. 5, the threshold setter F2 may set 40% as the lower limit threshold Th1 and set 70% as the upper limit threshold Th2, when the internal temperature Tin of the auxiliary battery 2B is equal to or higher than the first temperature T1 and lower than the second temperature T2.

The lower limit threshold Th1 and the upper limit threshold Th2 may be set in view of both the deterioration of the auxiliary battery 2B and the output characteristic of the auxiliary battery 2B, when the auxiliary battery 2B is at a temperature between the first temperature T1 and the second temperature T2.

In some embodiments, the lower limit threshold Th1 and the upper limit threshold Th2 may be set in a stepless manner based on the internal temperature Tin.

In some embodiments, the lower limit threshold Th1 may be calculated by the following Expression 1, based on the internal temperature Tin.

Th1=−(x×Tin)+Y Expression 1

In the above Expression 1, the unit of the lower limit threshold Th1 is percent (%). In addition, “X” and “Y” in the Expression 1 are each a constant.

The constant “X” may define the degree to which the management of the SOC of the auxiliary battery 2B is to be offset downward with respect to the temperature change of one (1) degree centigrade. For example, the SOC may be so managed that a charge amount is 1% lower every time the internal temperature Tin is increased by 2 degrees centigrade, where X=0.5. In one example where the SOC is managed between 50% and 80%, the SOC may be managed between 49% and 79% with the increase in the internal temperature Tin by two degrees centigrade.

The constant Y may be determined based on a way in which the SOC of the auxiliary battery 2B is to be managed. For example, the constant Y may be set at a lower level when the SOC of the auxiliary battery 2B is to be managed at a lower level, and may be set at a higher level when the SOC is to be managed at a higher level. In some embodiments, the constant Y may be determined based on a type of the auxiliary battery 2B.

In some embodiments, the upper limit threshold Th2 may be calculated by the following Expression 2, based on the internal temperature Tin.

Th2=−(X×Tin)+Y+30=Th1+30 Expression 2

In the above Expression 2, the unit of the upper limit threshold Th2 is percent (%).

The SOC monitor F3 may receive data on the SOC of the auxiliary battery 2B and manage the SOC of the auxiliary battery 2B. The SOC monitor F3 may supply the data on the SOC of the auxiliary battery 2B to the charging controller F4.

The charging controller F4 may start or stop the charging of the auxiliary battery 2B, based on the data on the SOC received from the SOC monitor F3. In some embodiments, the charging of the auxiliary battery 2B by the charging controller F4 may be performed in a ready ON state of the vehicle 100 in which a powertrain is activated and the vehicle 100 is able to travel accordingly, and also in a ready OFF state of the vehicle 100.

The charging controller F4 may perform a charging control of the auxiliary battery 2B, based on the lower limit threshold Th1 and the upper limit threshold Th2 set by the threshold setter F2 and the SOC of the auxiliary battery 2B obtained by the SOC monitor F3.

For example, the charging controller F4 may start the charging of the auxiliary battery 2B, when the SOC of the auxiliary battery 2B is less than the lower limit threshold Th1.

The charging controller F4 may instruct the activation controller F5 to activate each component, when the charging of the auxiliary battery 2B is to be started in the ready OFF state.

The activation controller F5 may start up the high-voltage battery ECU 1B and activate the traveling battery 2A via the high-voltage battery ECU 1B, based on an instruction from the charging controller F4. The activation controller F5 may also activate the generator 5, based on an instruction from the charging controller F4.

The charging controller F4 may perform the charging control of the auxiliary battery 2B with an appropriate voltage obtained as a result of stepping down, by the generator 5, a high voltage supplied from the traveling battery 2A, in response to the activation controller F5 activating each component.

The charging controller F4 may stop the charging of the auxiliary battery 2B, when the SOC of the auxiliary battery 2B is equal to or greater than the upper limit threshold Th2.

### 3. Example of Charging Control

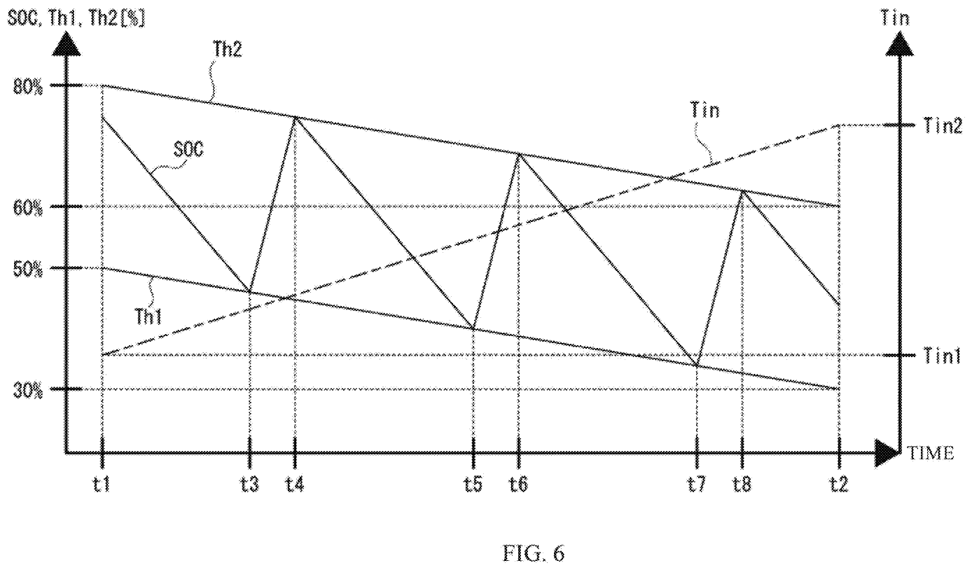

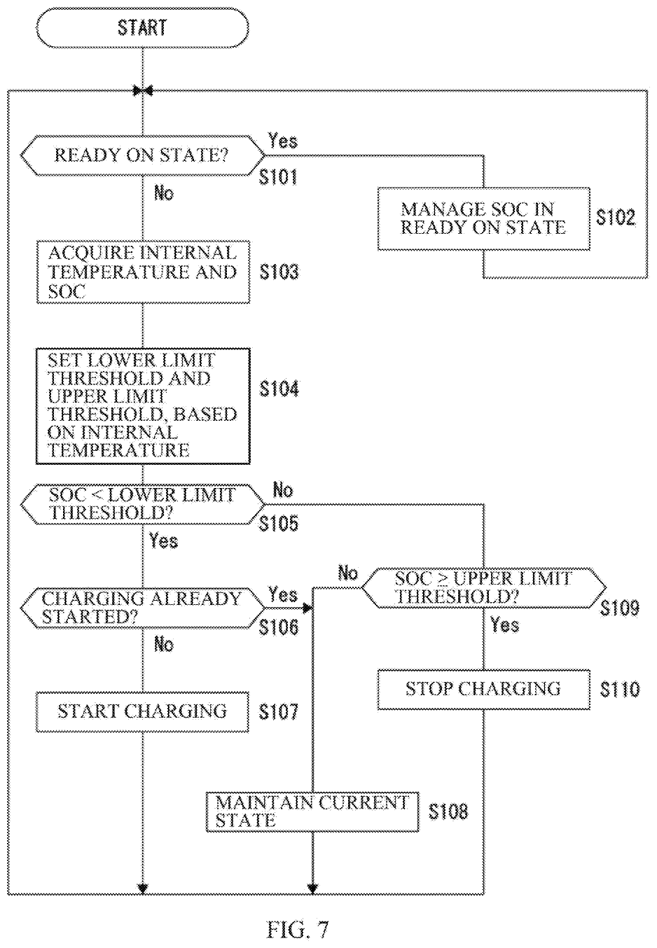

FIG. 6 illustrates an example of a charging control process to be performed by the central ECU 1A. Note that FIG. 6 illustrates a change in the SOC of the auxiliary battery 2B and changes in the lower limit threshold Th1 and the upper limit threshold Th2 when the internal temperature Tin of the auxiliary battery 2B increases with an elapse of time. In addition, FIG. 6 illustrates an example embodiment in which the lower limit threshold Th1 and the upper limit threshold Th2 are respectively set based on the Expressions 1 and 2.

Note that the powertrain is not activated and the vehicle 100 is placed in the ready OFF state.

As illustrated by a dashed-dotted line in FIG. 6, the internal temperature Tin of the auxiliary battery 2B may increase at a constant increase rate from a timing t1 to a timing t2.

Accordingly, the lower limit threshold Th1 and the upper limit threshold Th2 may be so set as to be gradually decreased from the timing t1 to a timing t3.

The SOC of the auxiliary battery 2B may gradually decrease from the timing t1 to the timing t3. A period from the timing t1 to the timing t3 may be a non-charging period in which the auxiliary battery 2B is not charged. At the timing t3, the charging of the auxiliary battery 2B may be started when the SOC of the auxiliary battery 2B reaches the lower limit threshold Th1, and the SOC of the auxiliary battery 2B starts to increase accordingly.

A period from the timing t3 to a timing t4 may be a charging period of the auxiliary battery 2B.

A period from the timing t4 to a timing t5 may be the non-charging period of the auxiliary battery 2B.

Accordingly, the charging period and the non-charging period of the auxiliary battery 2B may be repeated as described above. This configuration helps to achieve both: the prevention of the vehicle 100 from becoming difficult to travel or becoming unable to travel due to a difficulty in restarting a system of the vehicle 100 resulting from an excessive decrease in the SOC; and the prevention of the deterioration of the auxiliary battery 2B due taon excessive increase in the SOC of the auxiliary battery 2B.

In addition, the lower limit threshold Th1 and the upper limit threshold Th2 which respectively serve as determination thresholds for the start and the stop of the charging of the auxiliary battery 2B may be appropriately set again based on the internal temperature Tin of the auxiliary battery 2B at the relevant time.

This configuration helps to suppress the degradation of the auxiliary battery 2B due to the change in the internal temperature Tin, and achieve the prevention of a system of the vehicle 100 from becoming difficult to start up or becoming unable to start up due to a decrease in an output characteristic of the auxiliary battery 2B.

Note that the constant “X” in the Expression 1 may be set to “1” and the constant “Y” may be set to “80” when the internal temperature Tin at the timing t1 is set to 30 degrees centigrade and the internal temperature Tin at the timing t2 is set to 50 degrees centigrade in an example embodiment illustrated in FIG. 6.

In addition, although the lower limit threshold Th1 and the upper limit threshold Th2 may be changed based on the internal temperature Tin of the auxiliary battery 2B, any embodiment of the disclosure is not limited thereto. In some embodiments, the changes in the lower limit threshold Th1 and the upper limit threshold Th2 each may be limited to a predetermined range.

For example, a range in which the lower limit threshold Th1 is settable may be “from 20% to 50%”, and a range in which the upper limit threshold Th2 is settable may be “from 50% to 80%”. In this case, the lower limit threshold of 20% may be adopted as a lower limit of the range in which the lower limit threshold Th1 is settable, even if the lower limit threshold Th1 is calculated to be 10% by the Expression 1. Similarly, even if the upper limit threshold Th2 is calculated to be 90% by the Expression 2, the upper limit threshold of 80% may be adopted as an upper limit of the range in which the upper limit threshold Th2 is settable.

### 4. Example of Charging Control Process

FIG. 7 illustrates an example of the charging control process to be executed by the central ECU 1A.

In step S101, the central ECU 1A may determine whether the vehicle 100 is in the ready ON state. If the central ECU 1A determines that the vehicle 100 is in the ready ON state (step S101: Yes), the central ECU 1A may cause the process to proceed to step S102. In step S102, the central ECU 1A may start or stop the charging of the auxiliary battery 2B on an as-necessary basis by managing the SOC of the auxiliary battery 2B in the ready ON state.

After completing the process of step S102, the central ECU 1A may execute the process of step S101 again.

For example, during the ready ON state of the vehicle 100, the central ECU 1A may continuously perform the management of the SOC in the ready ON state while detecting a change in state of the vehicle 100 from the ready ON state to the ready OFF state.

If the ready OFF state is detected in step S101 (step S101: No), for example, if the vehicle 100 shifts to a parking state, the central ECU 1A may proceed to step S103. In step S103, the central ECU 1A may acquire the internal temperature Tin and the remaining charge amount (SOC) of the auxiliary battery 2B.

In step S104, the central ECU 1A may set the lower limit threshold Th1 and the upper limit threshold Th2, based on the internal temperature Tin.

In some embodiments, when the ranges in which the lower limit threshold Th1 and the upper limit threshold Th2 are settable are respectively set for the lower limit threshold Th1 and the upper limit threshold Th2, the central ECU 1A may determine whether the lower limit threshold Th1 and the upper limit threshold Th2 calculated in step S104 fall within their respective predetermined ranges. If not, the central ECU 1A may so set the lower limit threshold Th1 and the upper limit threshold Th2 that they fall within their respective predetermined ranges.

In step S105, the central ECU 1A may perform a branch process, based on a result of a comparison of the SOC of the auxiliary battery 2B with the lower limit threshold Th1.

For example, if the central ECU 1A determines in step S105 that the SOC of the auxiliary battery SOC is less than the lower limit threshold Th1 (step S105: Yes), the central ECU 1A may cause the process to proceed to step S106. In step S106, the central ECU 1A may determine whether the charging of the auxiliary battery 2B is already started.

If the central ECU 1A determines that the charging of the auxiliary battery 2B is not already started (step S106: No), the central ECU 1A may cause the process to proceed to step S107. In step S107, the central ECU 1A may start the charging of the auxiliary battery 2B. At this time, the central ECU 1A may activate each component to charge the auxiliary battery 2B with the traveling battery 2A as described above.

If the central ECU 1A determines that the charging of the auxiliary battery 2B is already started (step S106: Yes), the central ECU 1A may cause the process to proceed to step S108. In step S108, the central ECU 1A may maintain the current state, i.e., continue the charging of the auxiliary battery 2B.

After completing the process of step S107 or step S108, the central ECU 1A may return the process to step S101 again.

For example, the central ECU 1A may continue the charging of the auxiliary battery 2B, when the vehicle 100 is in the ready OFF state and the SOC of the auxiliary battery 2B is less than the lower limit threshold Th1.

In step S105, if the central ECU 1A determines that that the SOC of the auxiliary battery 2B is equal to or greater than the lower limit threshold Th1 (step S105: No), the central ECU 1A may cause the process to proceed to a branch process of step S109.

In the branch process of step S109, the central ECU 1A may determine whether the SOC is equal to or greater than the upper limit threshold Th2 by comparing the SOC of the auxiliary battery 2B with the upper limit threshold Th2.

If the central ECU 1A determines that SOC is equal to or greater than the upper limit threshold Th2 (step S109: Yes), the central ECU 1A may cause the process to proceed to step S110. In step S110, the central ECU 1A may stop the charging of the auxiliary battery 2B. If the charging of the auxiliary battery 2B is already stopped, a state in which the charging of the auxiliary battery 2B is stopped may be maintained.

After performing the process of stopping the charging of the auxiliary battery 2B in step S110, the central ECU 1A may return the process to step S101 again.

In step S109, if the central ECU 1A determines that the SOC is less than the upper limit threshold Th2 (step S109: No), i.e., if the central ECU 1A determines that the SOC of the auxiliary battery 2B is between the lower limit threshold Th1 and the upper limit threshold Th2, the central ECU 1A may cause the process to proceed to step S108. In step S108, the central ECU 1A may perform a process of maintaining a current state. At this time, when the charging of the auxiliary battery 2B is in progress, i.e., the auxiliary battery 2B is in the charging period, the central ECU 1A may continue the charging of the auxiliary battery 2B. When the charging of the auxiliary battery 2B is not in progress, i.e., the auxiliary battery 2B is in the non-charging period, the central ECU 1A may continue the state in which the charging of the auxiliary battery 2B is stopped.

After completing the process of step S108, the central ECU 1A may return the process to the branch processing of step S101.

For example, the central ECU 1A may manage the SOC of the auxiliary battery 2B while so starting or stopping the charging of the auxiliary battery 2B on an as-necessary basis that the SOC of the auxiliary battery 2B does not fall outside the lower limit threshold Th1 and the upper limit threshold Th2, while determining whether the vehicle 100 has made a transition from the ready OFF state to the ready ON state when the vehicle 100 is in the ready OFF state.

### 5. Conclusion

The vehicle 100 includes the controller 1. In one embodiment, the controller 1 may serve as a “charging control apparatus for a vehicle”. For example, the vehicle 100 includes the central ECU 1A and the high-voltage battery ECU 1B.

The controller 1 includes one or more processors and a storage medium that contains a program to be executed by the one or more processors. In some embodiments, the one or more processors may be the CPU 31. In some embodiments, the storage medium may be the ROM 32, the RAM 33, or the storage 38. The program includes one or more commands, and the one or more commands cause the one or more processors to execute at least the following four processes.

The four processes include: a process (e.g., step S103) that monitors the remaining charge amount (e.g., SOC) of the auxiliary battery 2B in the ready OFF state in which the vehicle 100 involves difficulty in traveling or unable to travel; a process (e.g., step S107) that starts the charging of the auxiliary battery 2B when the remaining charge amount of the auxiliary battery 2B becomes less than the lower limit threshold Th1 in the ready OFF state; a process (e.g., step S110) that stops the charging of the auxiliary battery when the remaining charge amount of the auxiliary battery 2B reaches the upper limit threshold Th2 in the ready OFF state, in which the upper limit threshold Th2 is a value larger than the lower limit threshold Th1; and a process (e.g., step S104) that sets the upper limit threshold Th2 and the lower limit threshold Th1, based on the temperature (e.g., the internal temperature Tin) of the auxiliary battery 2B.

This configuration variably changes the lower limit threshold Th1 and the upper limit threshold Th2 directed to the management of the SOC based on the internal temperature Tin, when, for example, the auxiliary battery 2B is the in-vehicle battery 2 such as the lithium-ion battery in which the deterioration is accelerated as the remaining charge amount becomes higher as the internal temperature Tin becomes higher and the output characteristic deteriorates as the remaining charge amount becomes lower as the internal temperature Tin becomes lower. Accordingly, this configuration helps to achieve both the suppression of the deterioration of the auxiliary battery 2B and the prevention of the deterioration of the output characteristic of the auxiliary battery 2B.

Note that the lower limit threshold Th1 and the upper limit threshold Th2 may be made variable based on the internal temperature Tin of the auxiliary battery 2B. In some embodiments, the lower limit threshold Th1 and the upper limit threshold Th2 may be made variable based on a surface temperature of the auxiliary battery 2B, instead of the internal temperature Tin. In some embodiments, the lower limit threshold Th1 and the upper limit threshold Th2 may be made variable based on a temperature of a space in which the auxiliary battery 2B is disposed, instead of the internal temperature Tin.

In some embodiments, the auxiliary battery 2B as the in-vehicle battery 2 to be mounted on the vehicle 100 may be the lithium-ion battery.

Managing the SOC at a higher value when the internal temperature Tin is high can further decrease the capacity which is decreased as a result of the reduction in the capacity with an aim to reduce a cost of the battery, when the lithium-ion battery is adopted as the auxiliary battery 2B.

Variably changing the lower limit threshold Th1 and the upper limit threshold Th2 based on the internal temperature Tin for such an auxiliary battery 2B helps to suitably suppress the further decrease in the capacity of the auxiliary battery 2B whose capacity is reduced.

The charging control apparatus for the vehicle according to at least one embodiment of the disclosure helps to suppress a further decrease in a charge capacity due to a deterioration of the auxiliary battery 2B whose capacity is reduced.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The controller 1 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the controller 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the controller 1 illustrated in FIG. 1.

1. A charging control apparatus for a vehicle, the charging control apparatus comprising:
one or more processors; and
a storage medium configured to store a program configured to be executed by the one or more processors,
the program comprising one or more commands, the one or more commands being configured to cause the one or more processors to
acquire a remaining charge amount of an auxiliary battery of the vehicle and a temperature of the auxiliary battery in a ready OFF state in which the vehicle involves difficulty in traveling,
start charging of the auxiliary battery when the remaining charge amount of the auxiliary battery is less than a lower limit threshold, the lower limit threshold comprising a value that is configured to prevent a system of the vehicle from becoming difficult to start,
stop the charging of the auxiliary battery when the remaining charge amount of the auxiliary battery is equal to or greater than an upper limit threshold, the upper limit threshold comprising a value greater than the lower limit threshold, and
repeatedly execute a charging control process that comprises setting, based on the temperature of the auxiliary battery, the upper limit threshold and the lower limit threshold.

2. The charging control apparatus for the vehicle according to claim 1, wherein
the auxiliary battery comprises a lithium-ion battery, and
the upper limit threshold and the lower limit threshold satisfy the following respective Expressions 1 and 2:
Th1=−(X×Tin)+Y Expression 1
Th2=Th1+Z Expression 2
where Th1 is the lower limit threshold, Th2 is the upper limit threshold, Tin is the temperature of the auxiliary battery, and X, Y, and Z are each a positive constant.

3. The charging control apparatus for the vehicle according to claim 1, wherein The ready ON state comprises a state in which a powertrain of the vehicle is activated, and the ready OFF state comprises a state in which the powertrain of the vehicle is not activated.
